(19) United States
(12) Patent Application Publication
(10) Pub. No.: US 2017/0086557 A1
(43) Pub. Date: Mar. 30, 2017

(54) Mobile phone case with receiving slot

(71) Applicant: Verus USA LLC, Brea, CA (US)

(72) Inventor: Sam Suk CHOI, Goyang-si (KR)

(21) Appl. No.: 15/081,264

(22) Filed: Mar. 25, 2016

(30) Foreign Application Priority Data
Sep. 25, 2015 (KR) 30-2015-0048891

(51) Int. Cl. A45C 15/00; A45C 1/06; A45C 11/00; H04B 1/3888

(52) U.S. Cl. CPC A45C 15/00; H04B 1/3888; A45C 1/06; A45C 11/00; A45C 2001/067; A45C 2011/002

(57) ABSTRACT

A mobile phone case includes a front portion and a rear portion. The front portion comprises a front opening, side walls, a floor, a rear surface, a receiving groove enclosed by the side walls and the floor, and a receiving slot provided on the rear surface and adapted to receive sheet-shaped items. The rear portion comprises a side edge portion configured for receiving and holding the rear surface and a part of the side walls of the front portion, an accessing opening provided through a bottom plate and aligned with the receiving slot of the front portion, and a clip portion extending from a first side of the accessing opening and covering a substantial portion of the accessing opening and configured for holding the sheet-shaped items in the receiving slot of the front portion.

### BACKGROUND OF THE INVENTION

The present invention relates to a mobile phone case with receiving slot.

With the advent of era of mobile communication devices, the protecting cases for the devices have gotten popular.

Sometimes, such cases could be improved drastically by adding new functions.

Accordingly, a need for a mobile phone case with receiving slot has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a mobile phone case with receiving slot, which can facilitate the use the mobile phone case to hold or store credit cards and the like.

An aspect of the invention provides a mobile phone case comprising a front portion and a rear portion.

The front portion comprises a front opening, side walls, a floor blocking a bottom surrounded by the side walls, a rear surface, a receiving groove enclosed by the side walls and the floor and adapted to receive a rear surface and side surfaces of a mobile phone and hold an edge portion of a front surface of the mobile phone, and a receiving slot provided on the rear surface and adapted to receive one or more sheet-shaped items.

The rear portion comprises a side edge portion configured for receiving and holding the rear surface and a part of the side walls of the front portion, an accessing opening provided through a bottom plate and aligned with the receiving slot of the front portion, and a clip portion extending from a first side of the accessing opening and covering a substantial portion of the accessing opening and configured for holding the one or more sheet-shaped items in the receiving slot of the front portion.

The side walls of the front portion may comprise a holding edge curved over and holding the edge portion of the front surface of the mobile phone.

The receiving slot may be surrounded by three vertical walls from three directions except for a second side disposed in an opposite side of the first side of the rear portion, so that the one or more sheet-shaped items are confined by the vertical walls in the three directions and received and extracted through the second side.

The three vertical walls of the receiving slot of the front portion may be covered by inner edges around the accessing opening of the rear portion.

A side wall in the second side of the rear portion may be flush with a bottom surface of the receiving slot of the front portion.

The clip portion may be elastically bent slightly inwards so as to catch and hold the one or more sheet-shaped items.

The side walls may be curved and comprise front parts and rear parts depressed inwards, and the front parts may meet the rear parts with step portions provided between the front parts and rear parts.

The rear surface of the front portion may be connected with the rear parts of the side walls.

The mobile phone case may further comprise a front locking part and a rear locking part.

The front locking portion is provided along the step portions of the side walls, and the rear locking portion is provided along edges of the rear portion contacting the step portions of the side walls of the front portion.

The clip portion may comprise an outer edge portion bent slightly outwards, so that a user's finger lifts the outer edge portion upwards and extracts the one more more sheet-shaped items.

Each of the front portion and the rear portion may comprise a plurality of openings for accessing control buttons of the mobile phone.

Each of the front portion and the rear portion may be made of thermoplastic polyurethane (TPU), polycarbonate (PC), metal, or synthetic resins.

The front portion and the rear portion may be made monolithically.

The advantages of the present invention are: (1) the mobile phone case according to the invention provides a convenient and secure means to store credit cards; and (2) the mobile phone case according to the invention provides structural features, in which the mobile phone case can be assembled and installed to the mobile phone conveniently.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a mobile phone case according to an embodiment of the invention;

FIG. 2 is a front view showing the mobile phone of FIG. 1;

FIG. 3 is a rear view showing the mobile phone of FIG. 1;

FIG. 4 is a left side view showing the mobile phone of FIG. 1;

FIG. 5 is a right view showing the mobile phone of FIG. 1;

FIG. 6 is a top view showing the mobile phone of FIG. 1;

FIG. 7 is a bottom view showing the mobile phone of FIG. 1;

FIG. 8 is an explosed view showing the mobile phone of FIG. 1 before storing credit cards; and

FIG. 9 is a rear view showing the mobile phone case of FIG. 1 with a credit card being inserted to the mobile phone case.

### DETAILED DESCRIPTION EMBODIMENTS OF THE INVENTION

Referring to the figures, the embodiments of the invention are described in detail.

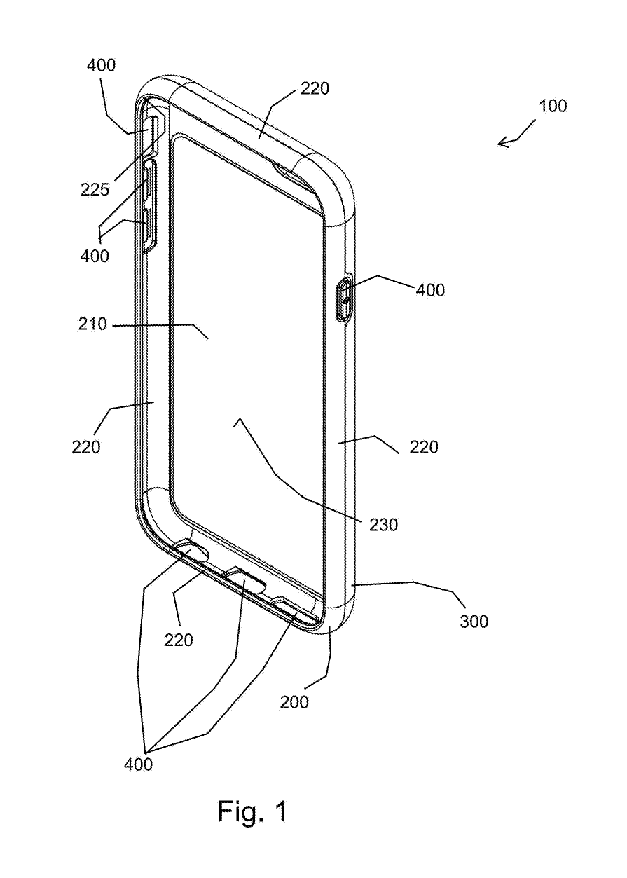

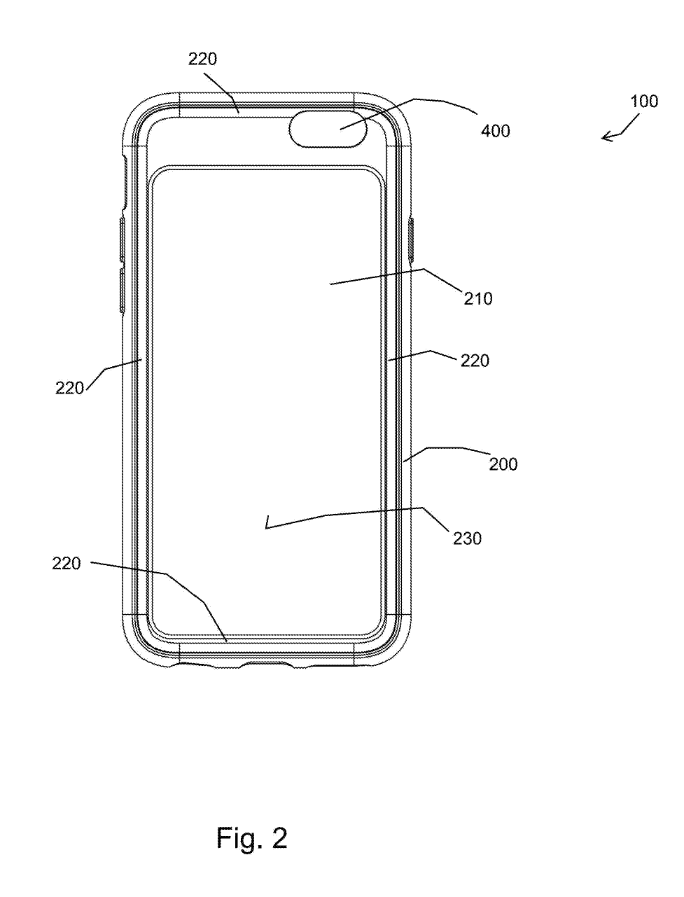

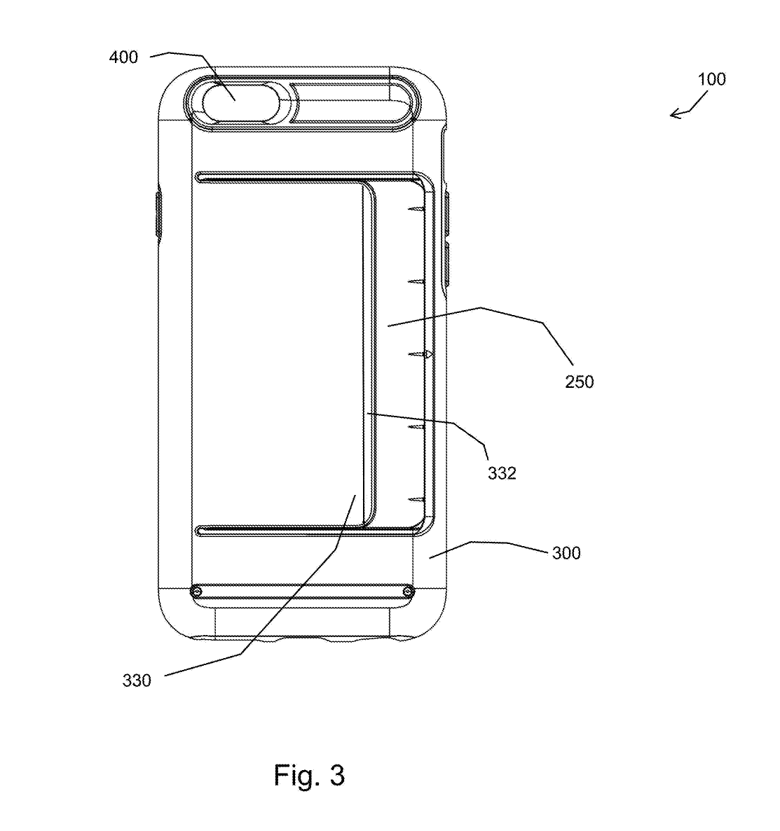

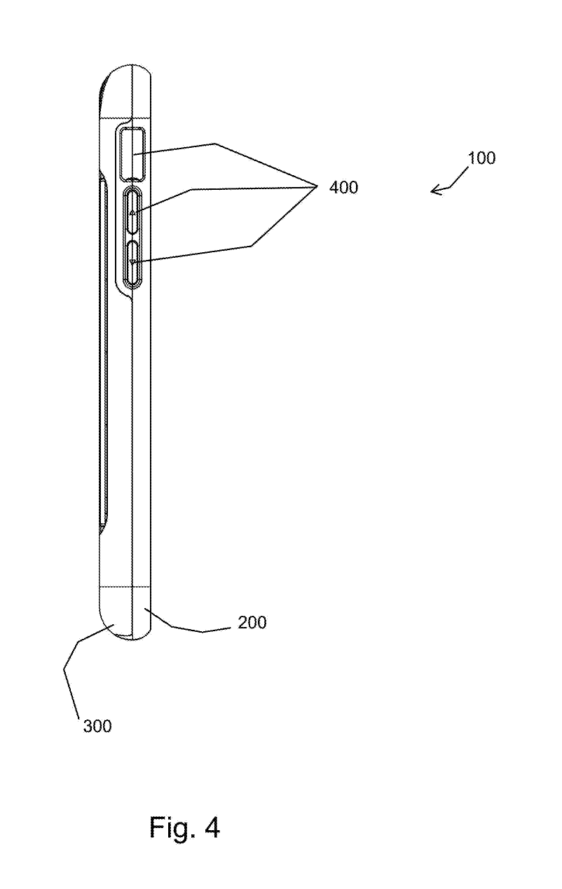

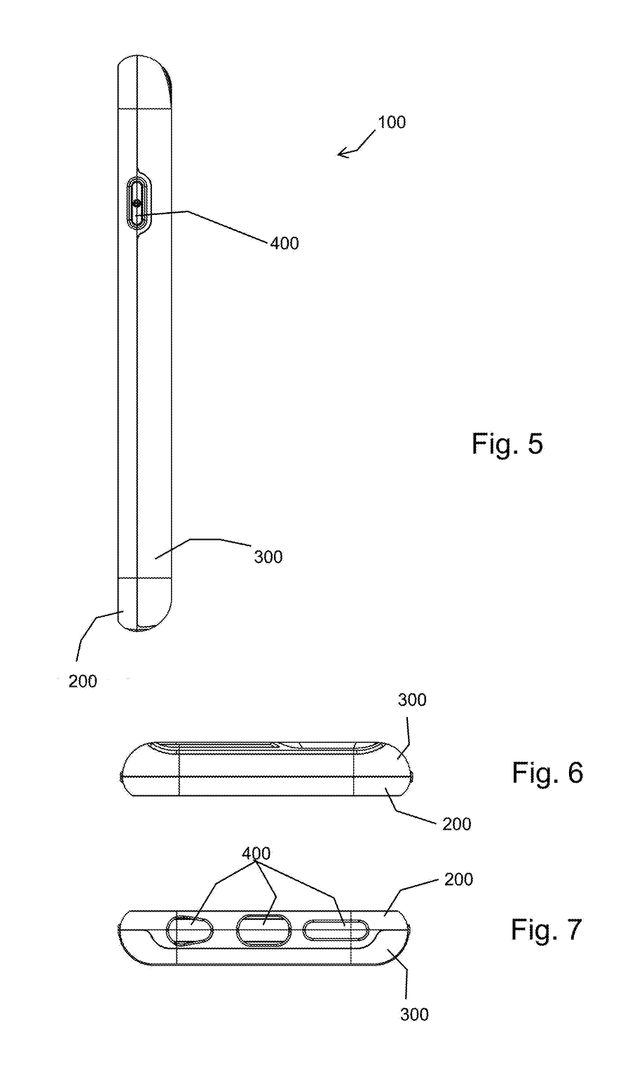

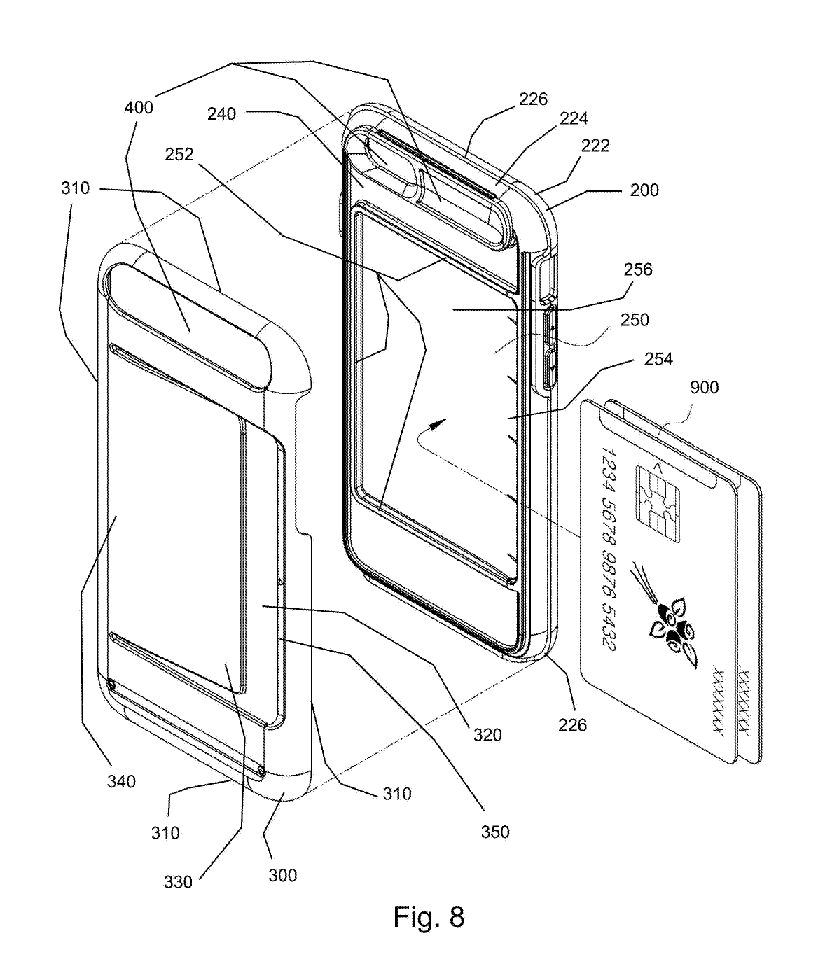

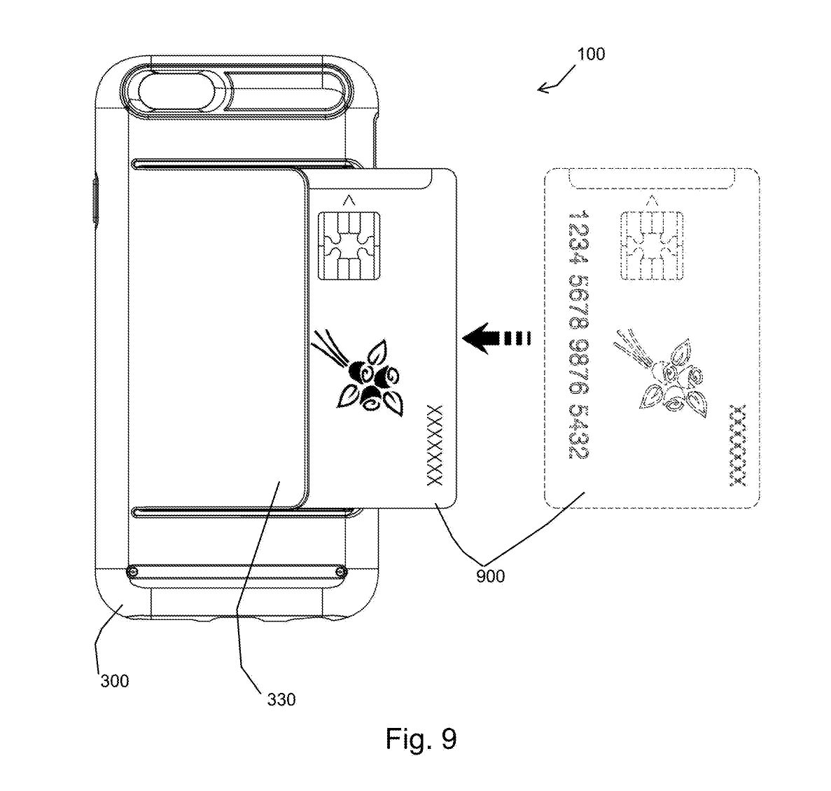

FIGS. 1 through 7 show a mobile phone case according to an embodiment of the present invention, and FIGS. 8-9 show how the credit card is stored in the mobile phone case according to the invention.

An aspect of the invention provides a mobile phone case 100 comprising a front portion 200 and a rear portion 300.

As shown mainly in FIG. 1, the front portion 200 comprises a front opening 210, side walls 220, a floor 230 blocking a bottom surrounded by the side walls 220, a rear surface 240, a receiving groove 250 enclosed by the side walls 220 and the floor 230 and adapted to receive a rear surface and side surfaces of a mobile phone (not shown) and hold an edge portion of a front surface of the mobile phone, and a receiving slot 250 provided on the rear surface 240 and adapted to receive one or more sheet-shaped items 900.

As shown mainly in FIG. 8, the rear portion 300 comprises a side edge portion 310 configured for receiving and holding the rear surface 240 and a part of the side walls 220 of the front portion 200, an accessing opening 320 provided through a bottom plate 330 and aligned with the receiving slot 250 of the front portion 200, and a clip portion 330 extending from a first side 340 of the accessing opening 320 and covering substantial portion of the accessing opening 320 and configured for holding the one or more sheet-shaped items 900 in the receiving slot 250 of the front portion 200.

The side walls 220 of the front portion 200 may comprise a holding edge 225 curved slightly over and holding the edge portion of the front surface of the mobile phone as shown in FIG. 1. The exact inner surfaces of the side walls 220 may depend on a specific mobile phone, so that it can receive and hold tight. The outer surface of the side walls 220 may be modified to a desirable shape with different curvature and angles if necessary.

The receiving slot 250 may be surrounded by three vertical walls 252 from three directions except for a second side 254 disposed in an opposite side of the first side 340 of the rear portion 300, so that the one or more sheet-shaped items 900 are confined by the vertical walls 252 in the three directions and received and extracted through the second side 254, where there is no wall.

The three vertical walls 252 of the receiving slot 250 of the front portion 200 may be covered by inner edges (hidden in FIG. 8) around the accessing opening 320 of the rear portion 300, so that the one or more sheet-shaped items 900 can be stored in a sheet-shaped slot opened only to a single direction.

A side wall 350 of the rear portion 300 CLOSE TO the second side 254 when assembled may be flush with a bottom surface 256 of the receiving slot 250 of the front portion 200, so that the one or more sheet-shaped items 900 can be easily pushed in or pulled out if the clip portion 330 is lifted a little.

The clip portion 330 may be elastically bent slightly inwards so as to catch and hold the one or more sheet-shaped items 900.

The side walls 220, the outer surface thereof, may be curved and comprise front parts 222 and rear parts 224 depressed inwards, and the front parts 222 may meet the rear parts 224 with step portions 226 provided between the front parts 222 and rear parts 224 as shown in FIG. 8.

The rear surface 240 of the front portion 200 may be connected with the rear parts 224 of the side walls 220.

The mobile phone case 100 may further comprise a front locking part and a rear locking part. For the locking mechanism between the front and rear locking parts, any conventional method or structures may be used as long as it makes the two parts locked securely and then unlocked when a force higher than a predetermined critical magnitude is applied.

The front locking portion is provided along the step portions 226 of the side walls 220, and the rear locking portion is provided along edges (hidden in FIG. 8) of the rear portion 300 contacting the step portions 226 of the side walls 220 of the front portion 300.

The clip portion 330 may comprise an outer edge portion 332 bent slightly outwards, so that a user's finger lifts the outer edge portion 332 upwards and extracts the one more more sheet-shaped items 900.

Each of the front portion 200 and the rear portion 300 may comprise a plurality of openings 400 for accessing control buttons of the mobile phone.

Each of the front portion 200 and the rear portion 300 may be made of thermoplastic polyurethane (TPU), polycarbonate (PC), metal, or synthetic resins.

In certain embodiments, the front portion 200 and the rear portion 300 may be made monolithically.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A mobile phone case comprising:
a front portion comprising a front opening, side walls, a floor blocking a bottom surrounded by the side walls, a rear surface, a receiving groove enclosed by the side walls and the floor and adapted to receive a rear surface and side surfaces of a mobile phone and hold an edge portion of a front surface of the mobile phone, and a receiving slot provided on the rear surface and adapted to receive one or more sheet-shaped items; and
a rear portion comprising a side edge portion configured for receiving and holding the rear surface and a part of the side walls of the front portion, an accessing opening provided through a bottom plate and aligned with the receiving slot of the front portion, and a clip portion extending from a first side of the accessing opening and covering a substantial portion of the accessing opening and configured for holding the one or more sheet-shaped items in the receiving slot of the front portion.

2. The mobile phone case of claim 1, wherein the side walls of the front portion comprise a holding edge curved over and holding the edge portion of the front surface of the mobile phone.

3. The mobile phone case of claim 1, wherein the receiving slot is surrounded by three vertical walls from three directions except for a second side disposed in an opposite side of the first side of the rear portion, so that the one or more sheet-shaped items are confined by the vertical walls in the three directions and received and extracted through the second side.

4. The mobile phone case of claim 3, wherein the three vertical walls of the receiving slot of the front portion are covered by inner edges around the accessing opening of the rear portion.

5. The mobile phone case of claim 4, wherein a side wall in the second side of the rear portion is flush with a bottom surface of the receiving slot of the front portion.

6. The mobile phone case of claim 1, wherein the clip portion is elastically bent slightly inwards so as to catch and hold the one or more sheet-shaped items.

7. The mobile phone case of claim 1, wherein the side walls are curved and comprise front parts and rear parts depressed inwards, and wherein the front parts meet the rear parts with step portions provided between the front parts and rear parts.

8. The mobile phone case of claim 7, wherein the rear surface of the front portion is connected with the rear parts of the side walls.

9. The mobile phone case of claim 8, further comprises:
a front locking portion provided along the step portions of the side walls; and
a rear locking portion provided along edges of the rear portion contacting the step portions of the side walls of the front portion.

10. The mobile phone case of claim 1, wherein the clip portion comprises an outer edge portion bent slightly outwards, so that a user's finger lifts the outer edge portion upwards and extracts the one more more sheet-shaped items.

11. The mobile phone case of claim 1, wherein each of the front portion and the rear portion comprises a plurality of openings for accessing control buttons of the mobile phone.

12. The mobile phone case of claim 1, wherein each of the front portion and the rear portion is made of thermoplastic polyurethane (TPU), polycarbonate (PC), metal, or synthetic resins.

13. The mobile phone case of claim 1, wherein the front portion and the rear portion are made monolithically.
